(19) United States
(12) Patent Application Publication
(10) Pub. No.: US 2008/0190552 A1
(43) Pub. Date: Aug. 14, 2008

(54) Method For Soldering Composite Material Parts

(76) Inventors: Eric Bouillon, Talence (FR); Sebastien Jimenez, Bordeaux (FR); Jacques Thebault, Bordeaux (FR)

Correspondence Address: WEINGARTEN, SCHURGIN, GAGNEBIN & LEBOVICI LLP, TEN POST OFFICE SQUARE, BOSTON, MA, 02109, US

(21) Appl. No.: 11/630,577

(22) PCT Filed: Jun. 22, 2005
(86) PCT No.: PCT/FR2005/001566

§ 371 Date: Nov. 5, 2007

(30) Foreign Application Priority Data
Jun. 24, 2004 (FR) 0406892

(51) Int. Cl. B29C 65/00; B23K 31/02; B23K 1/20

(52) U.S. Cl. 156/256; 228/121; 156/60; 156/278

(57) ABSTRACT

The invention relates to a method of brazing together two parts (10, 20), the method being characterized in that a pad (30) is interposed between the two surfaces (S10, S20) of the parts that are to be joined together, said pad being formed by a refractory fiber texture, and being at least in part in contact with a brazing composition (40), and heat treatment is performed to liquefy the brazing composition (40) so as to cause the molten brazing composition to be distributed by capillarity over the entire brazing area between the two parts (10, 20) covered by the pad (30).

### BACKGROUND OF THE INVENTION

The invention relates to brazing together thermostructural composite materials, and in particular ceramic matrix composite (CMC) materials. CMC materials are typically constituted by a porous substrate, such as a porous fiber substrate, densified by a ceramic matrix. The fibers of the substrate may be carbon fibers or ceramic fibers. The matrix is a refractory ceramic such as, for example, a refractory carbide, nitride, boride, or oxide. CMC materials, such as C/SiC (carbon fiber reinforcement and silicon carbide matrix) composite, for example, are remarkable for their mechanical properties that make them suitable for constituting structural elements, and for their ability to retain these properties at high temperatures.

When making structures out of ceramic matrix composite materials, it is common to build them up from independent elements of CMC material that are assembled together by brazing. Nevertheless, brazing ceramic matrix composite materials is technically difficult. These materials present a high degree of surface roughness and they include oxide phases. A brazed joint can be made only providing the oxide phases are eliminated. For this purpose, it is general practice to use brazing alloys or compositions based on silicon that require heat treatment at temperatures higher than 1200° C. Nevertheless, at such temperatures and above, eliminating the oxide phases present in the material leads to gaseous species being formed.

FIG. 1 is a highly diagrammatic view of two parts 1 and 2 of CMC composite material having surfaces S1 and S2 that are to be assembled together by the usual brazing technique, i.e. by interposing a layer of solid brazing composition 3 between the surfaces of the two parts to be joined. The layer of solid brazing composition 3 is then melted by heat treatment so as to form a brazed joint 31 connecting together the surfaces S1 and S2 of the two parts, as shown in FIG. 2. Nevertheless, with that brazing technique, some of the gaseous species given off by the material releasing oxygen become trapped within the brazed joint, which leads to a brazed joint that is porous in which there remain locally portions 4 without brazing between the two surfaces. This lack of material leads to defects in the connection between the two parts and consequently to degraded quality for the assembly, as shown in FIG. 3 which shows the state of a brazed joint obtained by the above-described standard brazing method. In FIG. 3, it can be seen that the distribution of brazing composition is not uniform because there remain pockets of gaseous species in the brazed joint, thereby weakening the resulting connection.

Those results can be improved, in particular by careful control over pauses during the temperature rise so as to implement an oxygen-removal pause prior to reaching the brazing temperature. An anti-wetting agent may also be used to “force” the passage of the brazing composition in the joint. FIGS. 4A and 4B (section IVB of FIG. 4A) show a brazed joint obtained between two CMC parts. There can be seen a clear improvement in the quality of the joint compared with that of FIG. 3, for example. Nevertheless, even with such improved control over the brazing method, some pockets still remain, leading to defects in the brazed joint.

Furthermore, those brazing techniques do not enable the thickness of the brazed joint to be controlled. Even with docking planes that have been lapped, the thickness of the resulting brazed joint can vary because of lack of uniformity in the distribution of the brazing composition during the heat treatment. Such variations in brazed joint thickness are further accentuated when the docking planes present irregularities (thicknesses e1 and e2 in FIG. 2).

### OBJECT AND SUMMARY OF THE INVENTION

An object of the invention is to provide a method enabling parts to be assembled together by brazing without the drawbacks mentioned above, in particular enabling the gaseous species produced during heat treatment to be removed and also enabling the thickness of the brazed joint and the contact between said joint and the brazed surfaces to be controlled.

This object is achieved with a method in which, in accordance with the invention, a pad is interposed between the two surfaces of the parts that are to be joined together, said pad being formed by a refractory fiber texture, and being at least in part in contact with a brazing composition, and heat treatment is performed to liquefy the brazing composition so as to cause the molten brazing composition to be distributed by capillarity over the entire brazing area between the two parts covered by the pad.

Thus, the pores in the fiber texture of the pad serve to bring the brazing composition by capillarity over the entire surface covered by the pad, while simultaneously facilitating removal of the gaseous species produced during the rise in temperature.

In addition, using such a pad makes it possible to control the final thickness of the brazed joint. By selecting the thickness of the pad, it is possible to control the final thickness of the brazed joint in a manner that is reproducible and accurate. Because of its flexibility, the pad also makes it possible to control contact with surfaces for brazing together even when such surfaces present irregularities. This provides continuous contact between the brazed joint and the brazed surfaces, enabling a connection to be obtained between the parts that is uniform and of good quality.

The pad may be constituted by a texture comprising carbon fibers or carbon-precursor fibers or ceramic fibers, where the ceramic may be silicon carbide (SiC).

In an aspect of the invention, the brazing composition is placed in contact with at least a portion of the pad outside the zone where the parts for brazing are docked together. During the rise in temperature, the molten composition is transported by capillarity between the surfaces of the parts for brazing over the entire area covered by the pad.

The pad may be cut to the shapes and sizes of the surfaces of the parts for brazing together. It is easily handled and can be matched to any shape of parts for brazing together. Thus, the zone over which it is desired to form a brazed joint can easily be defined in advance as the zone covered by the pad. It is then possible to make brazed joints that are strong on surfaces of all types, and to do so in a manner that is accurate and reproducible.

### BRIEF DESCRIPTION OF THE DRAWINGS

Other characteristics and advantages of the invention appear from the following description of particular implementations of the invention, given as non-limiting examples, with reference to the accompanying drawings, in which:

FIG. 1 is a highly diagrammatic view of brazing together two ceramic matrix composite material parts using the prior art;

FIG. 2 is a highly diagrammatic view of the result obtained by brazing together the two parts of FIG. 1;

FIG. 3 is a section view of a brazed joint obtained using the prior art;

FIGS. 4A and 4B show a brazed joint obtained using a prior art brazing method;

FIG. 5 is a flow chart showing the successive steps in an implementation of the method of the invention;

FIG. 6 is a diagram showing the implementation of a brazing operation using a dry pad in accordance with an implementation of the method of the invention;

FIG. 7 is a diagram showing the result obtained after brazing together the two parts of FIG. 6;

FIGS. 8A and 8B show a brazed joint obtained with the brazing method of the invention;

FIGS. 9A, 9B, and 9C show how a portion of a heat exchanger structure can be made by brazing together two parts in accordance with the invention of the invention; and

FIG. 10 shows an example of assembling together a plane part and a part that is honeycomb-shaped.

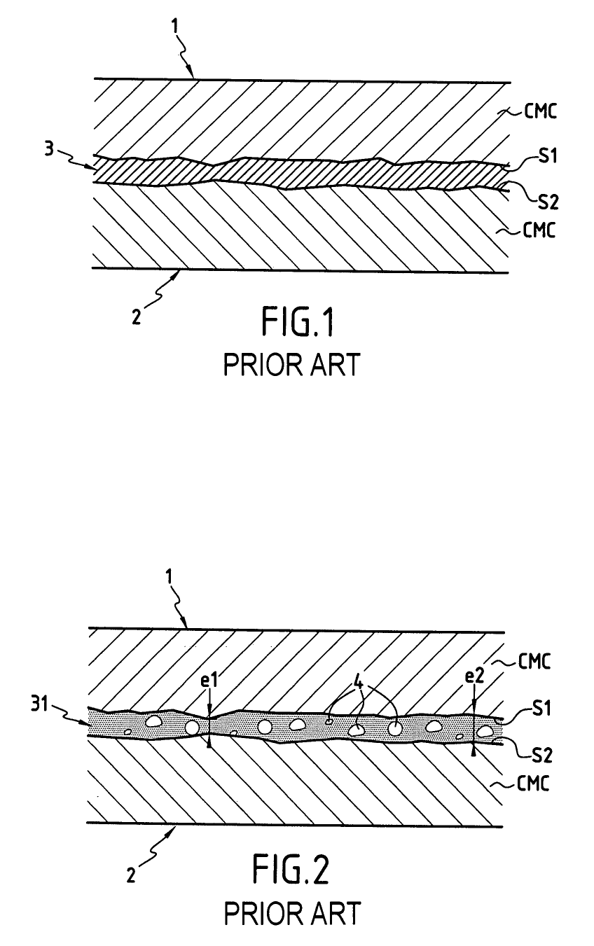

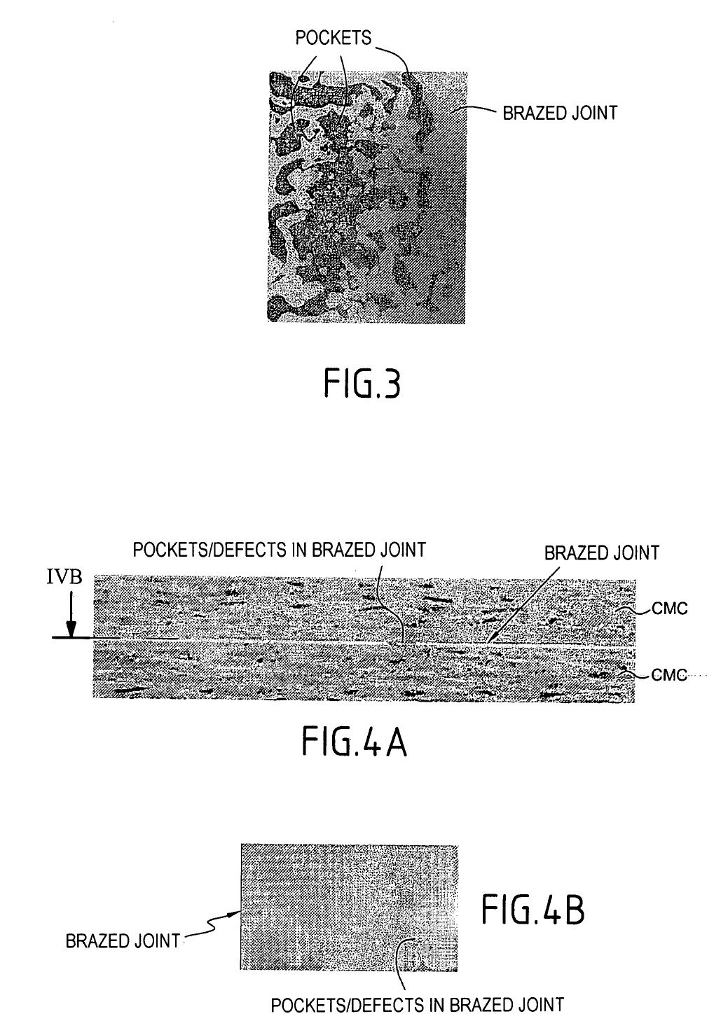

### DETAILED DESCRIPTION OF AN IMPLEMENTATION

The method of the present invention for assembling parts together by brazing applies to parts made of any thermostructural ceramic matrix composite (CMC) material, i.e. any material constituted by reinforcement of refractory fibers (carbon fibers or ceramic fibers) densified by a ceramic matrix that is also refractory, such as C/SiC, SiC/SiC, C/C—SiC materials, etc. The method also applies to other types of material that are liable to give off gaseous species during brazing, such as C/C materials or monolithic ceramics.

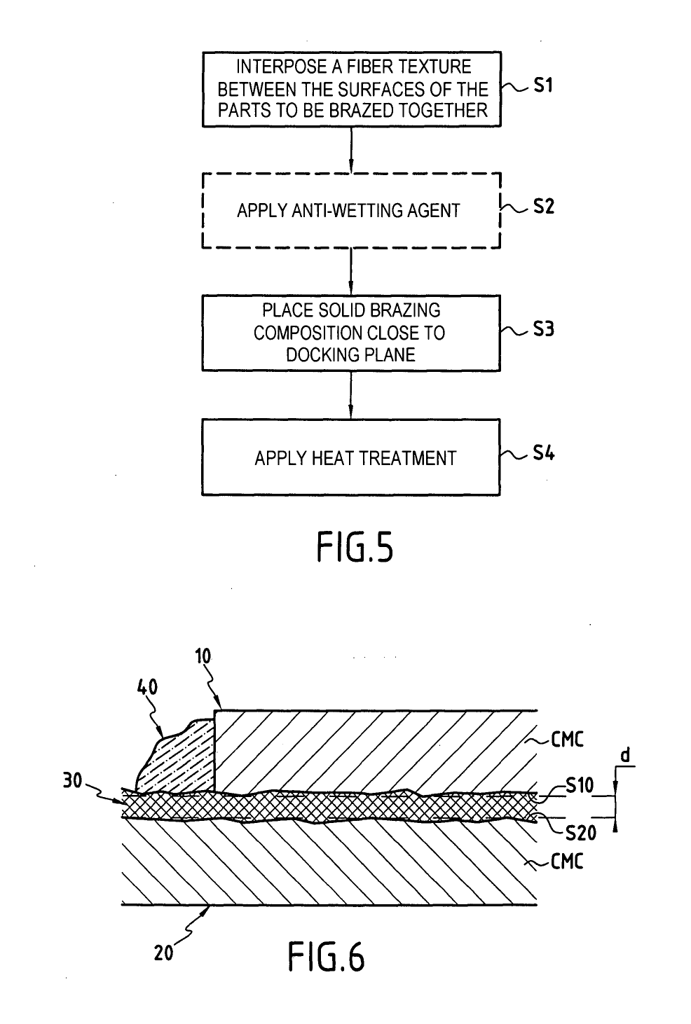

With reference to FIGS. 5 and 6, an implementation of a method in accordance with the invention for assembling together two parts 10 and 20 of CMC material by brazing comprises the following steps.

As shown in FIG. 6, the first step (step S1) consists in placing between the surface S10 of a first part 10 of CMC material and the surface S20 of a second part 20 likewise of CMC material, a “dry” (i.e. non-impregnated) pad 30 made of a texture of carbon fibers or of carbon-precursor fibers. In general, it is possible to make the brazing pad of the present invention by using any type of texture formed of carbon fibers or of carbon-precursor fibers or of ceramic fibers, such as SiC fibers, that is capable of transporting the brazing composition by capillarity and that presents sufficient porosity to make it possible to remove the gaseous species that are produced. By way of example, the pad may be in the form of a mat (i.e. agglomerated fibers in bulk), possibly a needled mat, a woven fabric, a felt, a two-dimensional (2D) texture, a unidirectional or multidirectional sheet, etc.

Optionally (step S2), an anti-wetting agent may be disposed on those zones of the parts that are not to be brazed (e.g. faces and edge faces that are not covered by the pad) so as to control the brazing flux, constraining it to wet only the pad covering those zones of the parts that are to be brazed. The anti-wetting agent used may be constituted, for example, by boron nitride (BN) packaged in the form of an aerosol, so-called “Stop-off” products such as the anti-wetting agent Stopyt® sold by the supplier Wesgo Metals or the Nicrobraz® products distributed by the supplier Wall Colmonoy Limited.

The following step (step S3) consists in placing a brazing composition 40 in contact with one (or more) portions of the pad 30 projecting beyond the docking plane between the two parts. By way of example, the brazing composition can be constituted by silicon compositions or silicon-based compositions such as those described in patent applications EP 0 806 402 or U.S. Pat. No. 5,975,407, silicon plus metallic silicide alloys, silicon plus optionally alloyed germanium, and metallic compositions known under the trade names Cusil-ABA®, Ticusil®, Incusil®, or Brasic®. The brazing composition is selected in particular as a function of its compatibility with the material of the parts, i.e. it is preferable to choose a composition that does not react with the material or that reacts therewith in controlled manner.

Thereafter, the temperature is raised until the brazing composition 40 becomes liquid, whereupon it is sucked by capillarity into the pad 30 and becomes distributed over the entire brazing area between the two parts covered by the pad (step S4). The gaseous species produced during the heat treatment are removed through the pores of the pad, thereby preventing pockets of gas forming within the brazed joint. The brazing front that advances through the pad pushes back the gaseous species that flow through the pores of the pad to the end of the pad where they are exhausted to the outside.

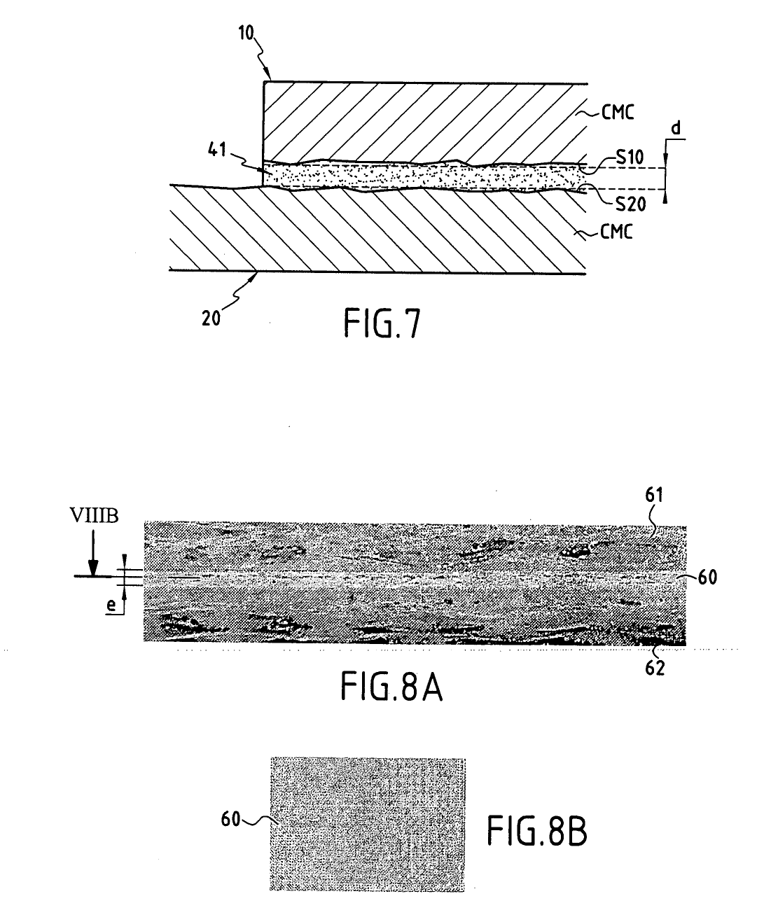

As shown very diagrammatically in FIG. 7, a brazed joint 41 is thus obtained that is continuously in contact with the surfaces S10 and S20 of the two parts. In addition, by using the pad of the invention, the final thickness of the brazed joint can be controlled. In accordance with the method of the invention, a fiber texture pad is interposed between the surfaces for brazing together of the parts. Consequently, the gap between these surfaces is defined by the thickness of the pad used, which pad forms an integral portion of the resulting brazed joint. Thus, the final thickness of the brazed joint can be determined as a function of the thickness selected for the pad that is used.

Furthermore, the use of such a pad makes it possible to guarantee some minimum thickness for the brazed joint, even when the docking planes present irregularities. As can be seen in FIG. 6, the surfaces S10 and S20 are held spaced apart from each other by a minimum distance d defined by the pad 30. The spacing between the two surfaces departs a little from this minimum distance depending on the sizes of irregularities present on the surfaces. Consequently, depending on the thickness of the pad, and possibly also on its compressibility, it is possible to define initially a minimum thickness for the brazed joint independently of the surface state of the parts that are to be joined together, which thickness is retained after brazing (distance d in FIG. 7).

Because of its flexibility, the pad matches the shape of the surface roughnesses, thus making it possible to control contact with the surfaces to be brazed together and to form a continuous brazed joint over the brazed-together surfaces in their entirety.

FIGS. 8A and 8B (section VIIIB in FIG. 8A) show a brazed joint 60 obtained with the above-described method and applied to connecting together two parts 61 and 62 made of CMC material. The pad used was constituted by a mat of carbon fibers. It can be seen that no residual pockets of gas were imprisoned in the joint, with the dark points present in the joint corresponding to grains of SiC formed by reaction between the brazing composition and the carbon of the pad. The brazed joint 60 presents a thickness e that is uniform over its entire length.

The use of a pad in accordance with the invention also presents the advantage of forming a diffusion medium for the brazing composition that adapts easily to parts of any shape. The pad is deformable and easy to cut out. Consequently, it can be cut to the dimensions and the shapes of the surfaces that are to be brazed together, and it can comply with the three-dimensional shape of the parts (non-planar parts).

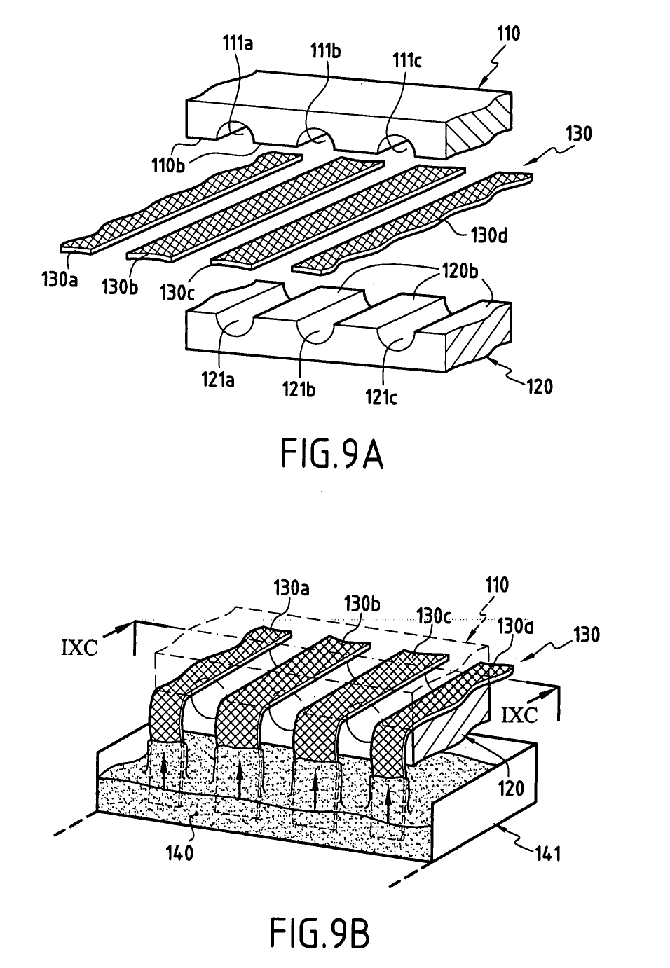

FIGS. 9A, 9B, and 9C show an example of making a structure by assembling together two panels 110 and 120 of CMC material (FIG. 9A), and specifically forming a portion of a heat exchanger structure 100 (FIG. 9C) of the kind used in the walls of a diverging portion of a thruster nozzle that is cooled by fluid flow.

Each of the panels 110 and 120 presents grooves or recesses 111a, 111b, 111c, and 121a, 121b, 121c for constituting flow channels for a fluid for cooling the structure. The recesses 111a-111c and 121a-121c respectively in the panels 110 and 120 define two independent brazing surfaces per panel (110a and 110b for panel 110 and 120a and 120b for panel 120).

In accordance with the present invention, a dry pad 130 is inserted between the surfaces of the panels that are to be joined together to form the fluid flow circuit. As shown in FIG. 9B, the pad 130 is made up of a plurality of portions 130a, 130b, 130c, and 130d cut to the dimensions and the shapes of the panel portions that are to be joined together.

As shown in FIG. 9B, the two panel surfaces are joined together with the portions 130a-130d of the pad 130 interposed against the contact zones, and with each portion having one end immersed in a crucible 141 containing a brazing composition 140. Thereafter, the temperature is raised until the brazing composition 140 becomes liquid, whereupon it is sucked in by capillarity by the portions 130a-130d of the pad 130 and spread over the entire area for brazing between the two parts covered by the pads.

As shown in FIG. 9C, this produces a structure 100 having fluid flow channels 150 spaced apart from one another by brazed joints 131 that are present solely in those zones that are covered by the portions 130a-130d of the pad 130.

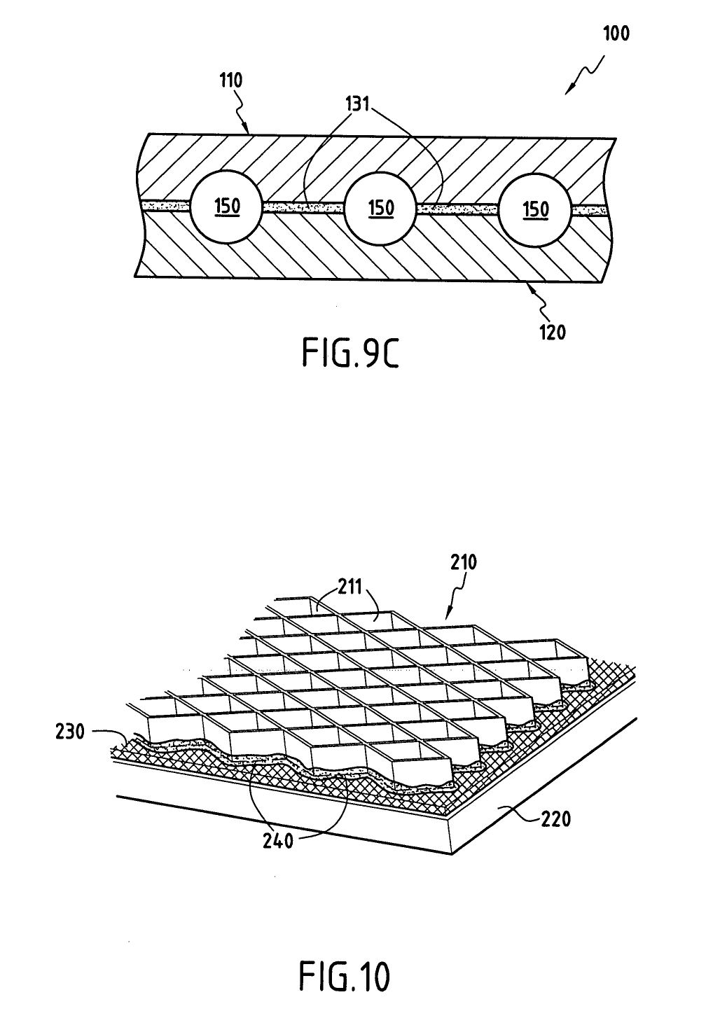

The brazing method of the present invention is particularly well adapted to assembling together parts presenting shapes that are complex and/or non-uniform. As shown in FIG. 10, it makes it easy, for example, to assemble together a solid part 220 with a part 210 that is honeycomb-shaped or waffle-shaped and includes a plurality of cells 211. With a standard brazing method, such parts are found to be particularly difficult to braze because of the difficulty of placing the brazing composition uniformly between the solid part 220 and the bottom edges of the cell 211, the only portions of the part 210 that can be joined to the part 220. With the method of the invention, the operation of performing assembly by brazing is made much easier by using a dry pad 230 making it possible to place a solid brazing composition 240 coarsely around and/or in the cells 211, the pad 230 then serving during the temperature rise to distribute the brazing composition uniformly over all of the zones of contact between the parts 210 and 220, i.e. between the bottom edges of the flanks of the cells 211 and the surface of the part 220.

1. A method of brazing together two parts the method being characterized in that a pad is interposed between the two surfaces of the parts that are to be joined together, said pad being formed by a refractory fiber texture, and being at least in part in contact with a brazing composition, and heat treatment is performed to liquefy the brazing composition so as to cause the molten brazing composition to be distributed by capillarity over the entire brazing area between the two parts covered by the pad.

2. A method according to claim 1, characterized in that at least one of the two parts is made of a ceramic matrix composite material, or a C/C composite material, or of a monolithic ceramic material.

3. A method according to claim 1, characterized in that the pad is formed by a texture comprising carbon fibers, or by fibers of a carbon-precursor material, or by ceramic fibers.

4. A method according to claim 1, characterized in that the brazing composition is placed in contact with at least a portion of the pad outside the docking zones of the surfaces of the parts to be brazed together.

5. A method according to claim 4, characterized in that the brazing composition is placed in a crucible, the brazing composition being transported by capillarity by the pad between the surfaces of the parts that are to be joined together during the heat treatment.

6. A method according to claim 1, characterized in that the thickness of the pad is selected as a function of the thickness of the brazed joint to be formed.

7. A method according to claim 1, characterized in that the pad is cut to the dimensions and to the shapes of the surfaces of the parts for brazing together.

8. A method according to claim 1, characterized in that, prior to the heat treatment step, an anti-wetting agent is applied to those portions of the parts that are not to be brazed together.

9. A method according to claim 1, characterized in that one of the two parts for assembling together is in the form of a honeycomb or a waffle.

10. A method according to claim 1, characterized in that the brazing composition is a silicon composition or a silicon-based composition, or a silicon alloy-based composition, or a metallic composition.

11. A method according to claim 2, characterized in that the brazing composition is placed in contact with at least a portion of the pad outside the docking zones of the surfaces of the parts to be brazed together.

12. A method according to claim 3, characterized in that the brazing composition is placed in contact with at least a portion of the pad outside the docking zones of the surfaces of the parts to be brazed together.

13. A method according to claim 11, characterized in that:
the brazing composition is placed in a crucible, the brazing composition being transported by capillarity by the pad between the surfaces of the parts that are to be joined together during the heat treatment;
the thickness of the pad is selected as a function of the thickness of the brazed joint to be formed;
the pad is cut to the dimensions and to the shapes of the surfaces of the parts for brazing together;
prior to the heat treatment step, an anti-wetting agent is applied to those portions of the parts that are not to be brazed together;
one of the two parts for assembling together is in the form of a honeycomb or a waffle;
the brazing composition is a silicon composition or a silicon-based composition, or a silicon alloy-based composition, or a metallic composition.

14. A method according to claim 12, characterized in that:
the brazing composition is placed in a crucible, the brazing composition being transported by capillarity by the pad between the surfaces of the parts that are to be joined together during the heat treatment;
the thickness of the pad is selected as a function of the thickness of the brazed joint to be formed;
the pad is cut to the dimensions and to the shapes of the surfaces of the parts for brazing together;
prior to the heat treatment step, an anti-wetting agent is applied to those portions of the parts that are not to be brazed together;
one of the two parts for assembling together is in the form of a honeycomb or a waffle;
the brazing composition is a silicon composition or a silicon-based composition, or a silicon alloy-based composition, or a metallic composition.
